(19) United States
(12) Patent Application Publication
(10) Pub. No.: US 2026/0301237 A1
(43) Pub. Date: Oct. 1, 2026

(54) LEARNING BASED BITWISE OCTREE ENTROPY CODING COMPRESSION AND PROCESSING IN LIGHT DETECTION AND RANGING (LIDAR) AND OTHER SYSTEMS

(71) Applicant: INTERDIGITAL VC HOLDINGS, INC., Wilmington, DE (US)

(72) Inventors: Muhammad Asad Lodhi, Highland Park, NJ (US); Jiahao Pang, Plainsboro, NJ (US); Junghyun Ahn, New York, NY (US); Dong Tian, Boxborough, MA (US)

(73) Assignee: INTERDIGITAL VC HOLDINGS, INC., Wilmington, DE (US)

(21) Appl. No.: 18/880,156

(22) PCT Filed: Jul. 12, 2023
(86) PCT No.: PCT/US2023/027509

§ 371 Date: Dec. 30, 2024

Related U.S. Application Data
(60) Provisional application No. 63/388,462, filed on Jul. 12, 2022.

(51) Int. Cl. G06T 9/40; G06T 9/00; G06T 17/00

(52) U.S. Cl. CPC G06T 9/40; G06T 9/002; G06T 17/00; G06T 2210/36; G06T 2210/56

(57) ABSTRACT

A device may access a set of occupancy bits of the neighboring voxels at a current level of detail (LoD) that are already encoded or decoded, using a tree-based point cloud decoder. The device may compute a feature, using a neural network module, based on the accessed voxels. The device may access a deep feature vector from a previous LoD. The device may combine the two features using another neural network module to obtain a new combined feature. The device may concatenate the new combined feature along with the known features of the current voxels to be encoded or decoded to compose a new comprehensive feature. The device may predict the probability distribution of the occupancy of voxels at the current LoD based on the comprehensive feature using yet another neural network module. One or more of the neural network modules may be convolution based neural network modules.

### CROSS REFERENCE TO RELATED APPLICATION

This application claims the benefit of U.S. Provisional Application No. 63/388,462, filed Jul. 12, 2022, the contents of which are incorporated herein by reference.

### BACKGROUND

Point cloud compression and processing develop compression, analysis, interpolation, representation and understanding of point cloud signals. A point cloud data format is a universal data format across several processing domains from autonomous driving, robotics, augmented reality (AR)/virtual reality (VR), civil engineering, computer graphics, to the animation/movie industry. Three dimensional (3D) light detection and ranging (LiDAR) sensors have been deployed in self-driving cars, and affordable LiDAR sensors have been released from various manufacturers. With advances in sensing technologies, 3D point cloud data has become more practical than ever and is expected to be an ultimate enabler in the applications mentioned.

Point cloud data is also believed to consume a large portion of network traffic, for example, among connected cars over fifth generation (5G) network and immersive communications, such as VR/AR enabled communications. Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

### SUMMARY

The embodiments and examples provided herein improve an binary voxel-based octree coding method through an enhanced method for context modeling. Given a current voxel to be encoded/decoded, its occupancy probability may be estimated based on the associated binary occupancy context at the current and parent level of detail (LoD). The enhanced method provided herein, however, operates on the resolution of the parent LoD to process the current and the parent binary contexts. Under this proposed model, there is no need for expensive upsampling operations, and the computational and memory complexity is reduced compared to existing learning based approaches.

In an example provided herein, a device, which may be a wireless device, such as a wireless transmit/receive unit (WTRU), may be configured to access a set of occupancy bits of the neighboring voxels at a current LoD that are already encoded or decoded, using a tree-based point cloud decoder. Further, the device may compute a first feature, using a first neural network module, based on the accessed set of occupancy bits of neighboring voxels at the current LoD. In an example, the first neural network module may be a first convolution based neural network module.

Also, the device may access a second feature. In an example, the second feature may be a deep feature vector from a previous LoD. Moreover, the device may combine the first and second features to obtain a new combined third feature.

In addition, the device may concatenate the new combined third feature along with the known features of the current voxels to be encoded or decoded to compose a new comprehensive fourth feature. In addition, the device may predict the probability distribution of the occupancy of voxels at the current LoD based on the comprehensive fourth feature using a second neural network module. In an example, the second neural network module may be a second convolution based neural network module. In another example, the second neural network module may be a fully connected (FC) module. In a further example, the second neural network module may be part of a multi-layer perceptron (MLP)-based module.

Further, the device may obtain a fifth feature, using a third neural network module, based on the second feature. In an example, the third neural network module may be a third convolution based neural network module. In an additional or alternative example, the fifth feature may be combined with the first feature to obtain the third feature.

In an additional example, the device may access a sixth feature. The sixth feature may be based on bits from already encoded or decoded voxels at the current LoD, in an example. In another example, the fifth feature may be obtained by combining the second feature and the sixth feature using the second neural network module or the third neural network model. Also, the fourth feature may be composed further based on the sixth feature combined with the third feature. Additionally or alternatively, the fourth feature may be composed further based on the second feature combined with the third feature.

In a further example, the prediction of the probability distribution of the occupancy of voxels at the current LoD may be further based on contextual information about the current voxels encoded or decoded. In another example, the second feature may be based on a first point cloud of the previous LoD. Also, the occupancy bits of the neighboring voxels at the current LoD may be received in a bitstream, in an example.

In yet a further example, the device may reconstruct an octree structure based on the probability distribution of the occupancy of the voxels at the current LoD. Further, the device may reconstruct a second point cloud based on leaf nodes of the reconstructed octree structure. Moreover, the device may then transmit bits of the second point cloud.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a construction diagram illustrating an example level of detail (LoD) construction of a point cloud;

FIG. 3 is an architectural diagram illustrating an example basic proposed architecture;

FIG. 4 is an architectural diagram illustrating an example unrolled basic proposed architecture;

FIG. 5A and FIG. 5B are an operation diagram illustrating an example of a prediction operation from bit to bit;

FIG. 6 is a flowchart diagram of an example of predicting voxel occupancy using occupancy bits of already encoded or decoded neighboring voxels;

FIG. 7 is a flowchart diagram of another example of predicting voxel occupancy using occupancy bits of already encoded or decoded neighboring voxels;

FIG. 8 is an architectural diagram illustrating an example of proposed architecture with residual connection from a feature of a previous level;

FIG. 9 is an architectural diagram illustrating an example of proposed architecture with residual connection from a feature of a previous bit;

FIG. 10 is an architectural diagram illustrating an example of proposed basic architecture with example network details; and

FIG. 11 is an extraction diagram illustrating examples of feature extraction from all previously decoded bits.

### DETAILED DESCRIPTION

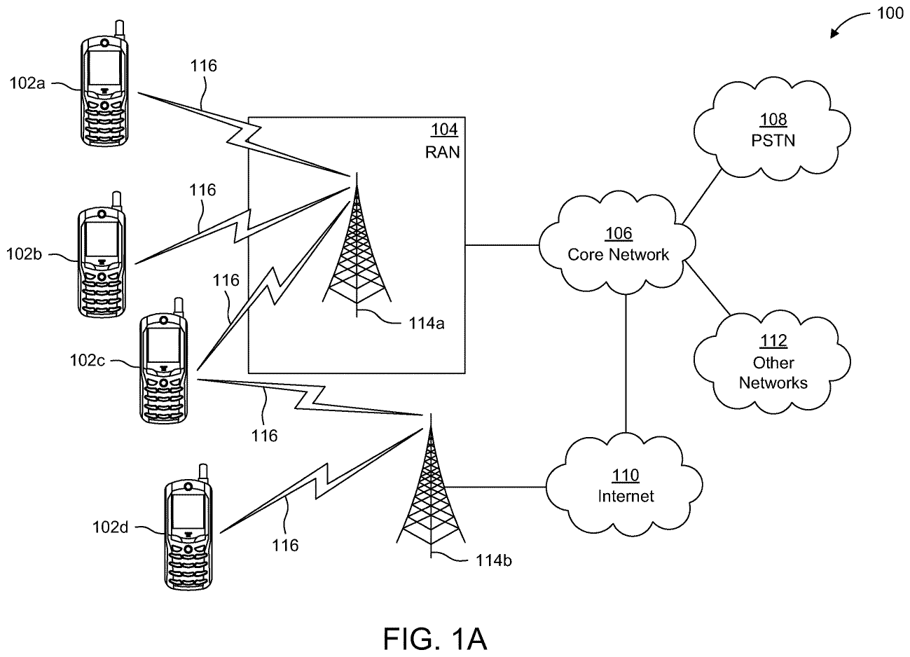

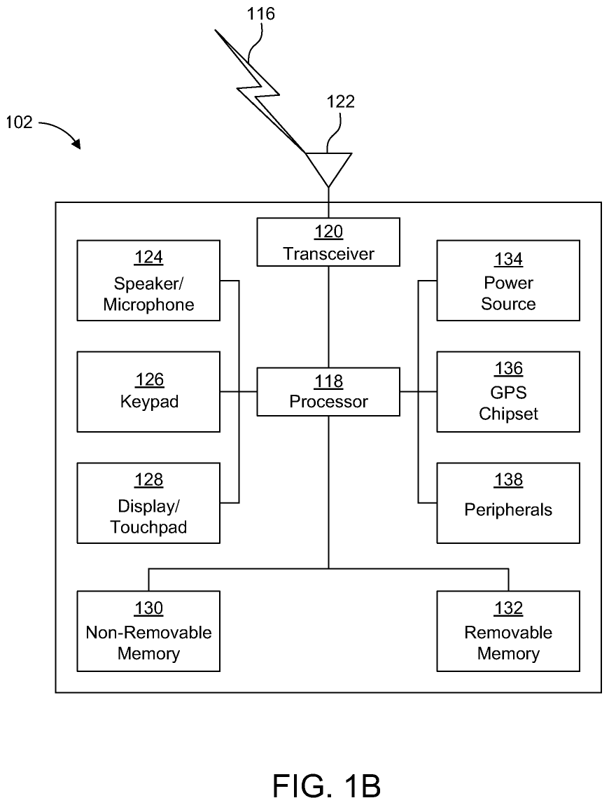

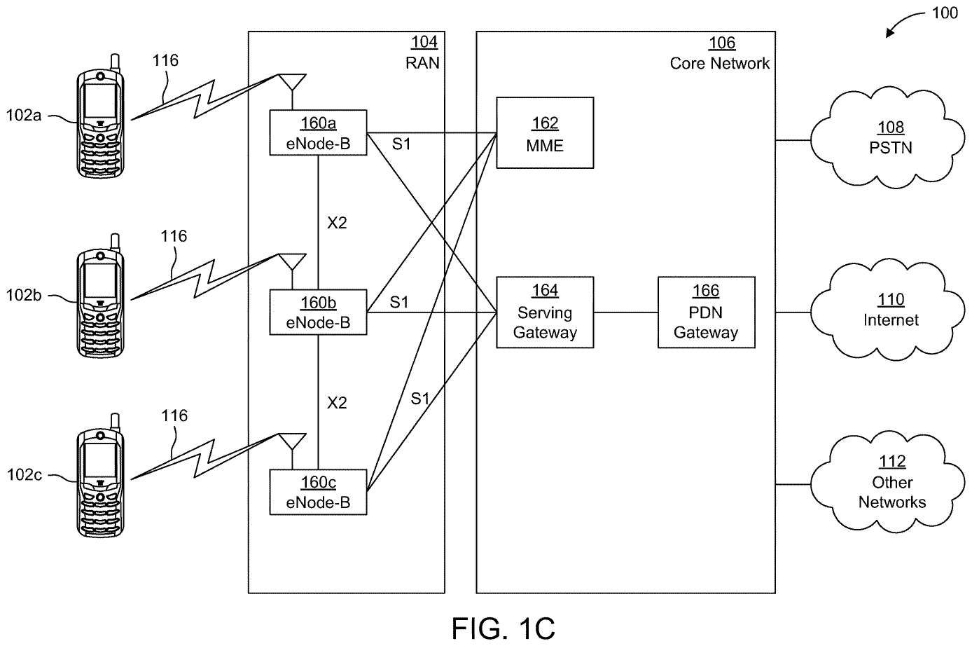

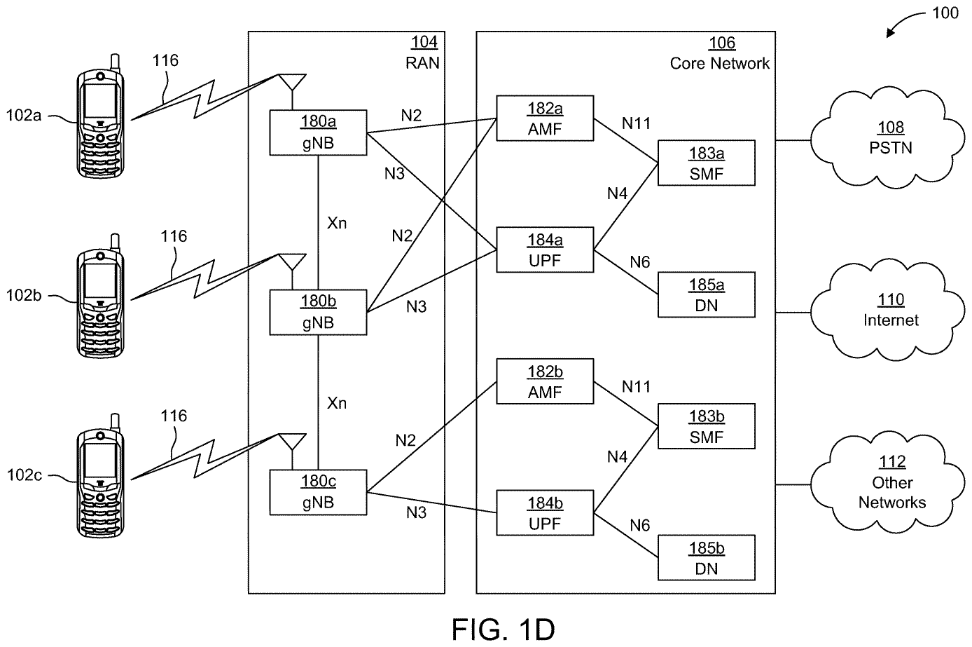

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the television (TV) White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Point cloud compression and processing develop compression, analysis, interpolation, representation and understanding of point cloud signals. A point cloud data format is a universal data format across several processing domains from autonomous driving, robotics, augmented reality (AR)/virtual reality (VR), civil engineering, computer graphics, to the animation/movie industry. Three dimensional (3D) light detection and ranging (LiDAR) sensors have been deployed in self-driving cars, and affordable LiDAR sensors have been released from various manufacturers. With advances in sensing technologies, 3D point cloud data has become more practical than ever and is expected to be an ultimate enabler in the applications mentioned.

Point cloud data is also believed to consume a large portion of network traffic, for example, among connected cars over fifth generation (5G) network and immersive communications, such as VR/AR enabled communications. Efficient representation formats are necessary for point cloud understanding and communication. In particular, raw point cloud data need to be properly organized and processed for the purposes of world modeling and sensing. Compression on raw point clouds is essential when storage and transmission of the data are required in the related scenarios.

Further, point clouds may represent a sequential scan of the same scene, which contains multiple moving objects. Such scene representations are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

The automotive industry and autonomous car are domains in which point clouds may be used, among several point cloud data use cases. Autonomous cars should be able to probe their environment to make good driving decisions based on the reality of their immediate surroundings. Typical sensors like LiDARs produce point clouds, which may be dynamic point clouds, that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

VR and immersive worlds have become a hot topic and foreseen by many as the future of two-dimensional (2D) flat video. The basic idea is to immerse the viewer in an environment all around oneself as opposed to standard TV where one can only look at the virtual world in front of oneself. There are several gradations in the immersivity depending on the freedom of the viewer in the environment. Point cloud is a good format candidate to distribute VR worlds. Point clouds may be static or dynamic, and are typically of averaged size, often no more than millions of points at a time.

Point clouds may be also used for various purposes such as cultural heritage/buildings in which objects like statues or buildings are scanned in 3D in order to share the spatial configuration of the object without sending or visiting it. Also, it is a way to ensure preserving the knowledge of the object in case it may be destroyed; for instance, a temple by an earthquake. Such point clouds are typically static, colored, and huge.

Another use case is in topography and cartography in which using 3D representations, maps, and the like are not limited to the plane and may include the relief. Map applications commonly available on the Internet are now good examples of 3D maps but often use meshes instead of point clouds. Nevertheless, point clouds may be a suitable data format for 3D maps and such point clouds are typically static, colored, and huge.

World modeling and sensing via point clouds could be an essential technology to allow machines to gain knowledge about the 3D world around them, which is crucial for the applications discussed above. Examples and embodiments provided herein may be applied with the foregoing in mind.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, for example, a smartphone, a tablet, a WTRU, an automotive navigation system, and the like, that may have limited computational power.

The first step for any processing or inference on the point cloud is to have efficient storage methodologies. To store and process the input point cloud with affordable computational cost, one solution is to down-sample it first, where the down-sampled point cloud summarizes the geometry of the input point cloud while having much fewer points. The down-sampled point cloud may then be fed to the subsequent machine task for further consumption. However, further reduction in storage space can be achieved by converting the raw point cloud data, original or downsampled, into a bitstream through entropy coding techniques for lossless compression. Better entropy models result in a smaller bitstream and hence more efficient compression. Additionally, the entropy models can be also paired with downstream tasks which allow the entropy encoder to maintain the task specific information while compressing.

In addition to lossless coding, many scenarios seek for lossy coding for a significantly improved compression ratio while maintaining induced distortion under certain quality levels. The splitting of occupied voxels continues until the last octree depth level. The leaves of the octree finally represent a point cloud.

On the encoder side, the octree nodes, or node values, are typically sent to an entropy coder to generate a bitstream. A decoder may then use the decoded octree node values to reconstruct the octree structure, and finally reconstruct a point cloud based on the leaf nodes of the octree structure. To efficiently entropy code the octree nodes, a probability distribution model is typically utilized to allocate a shorter symbol for octree node values which may appear with higher probability.

Point cloud compression is a critical problem in many practical applications, such as autonomous driving, AR/VR, and the like. The examples and embodiments provided herein specifically concern the lossless compression of voxelized point cloud data with a novel context modeling approach. Such an approach can provide solutions for problems in point cloud compression.

Point cloud compression may be performed via octree coding. Point clouds can be represented via an octree decomposition tree. In an octree decomposition tree, a root node covers a full space in a bounding box. The space is equally split in every direction, in other words, in x-axis, y-axis, and z-axis directions, leading to eight (8) voxels. For each voxel, if there is at least one occupied point, the voxel is marked to be occupied, represented by a ‘1’ value; otherwise, it is marked to be empty, represented by a ‘0’ value. The voxel splitting then continues until a pre-specified condition is met.

Octant-based octree coding examples are provided herein. A popular approach to encode an octree is by encoding each occupied voxel with an 8-bit value which indicates the occupancy of its individual octant. In this way, one may first encode the root voxel node by an 8-bit value. Then for each occupied voxel in the next level or level of detail (LoD), one may encode its 8-bit occupancy symbol, then move to the next LoD. This type of octree coding algorithm encoding the 8-bit occupancy symbols may be referred to as the octant-based method.

Binary voxel-based coding examples are provided herein. An alternative viewpoint to encode an octree is by directly encoding the binary occupancy bits. At each LoD, one may encode a sequence of occupancy bits representing the voxels at the current LoD, then the encoder moves onto the next LoD. This type of approach may be referred to as a binary voxel-based method. Examples and embodiments provided herein include this type of approach.

By comparing the two types of coding methods, one may see that in the octant-based method, the coding of a current voxel is in fact coding the occupancy symbols of its child voxels. Differently, in the binary voxel-based method, the coding of a current voxel is indeed coding the binary occupancy bit of its own. In the following, examples and embodiments review these two types of approaches in detail.

Examples and embodiments of octant-based octree coding are provided herein. Further, examples of learning based octree coding for point clouds are provided herein. Deep entropy models may refer to a category of learning-based approaches that attempt to formulate a context model using a neural network module to predict the probability distribution of the eight-bit (8-bit) occupancy symbols.

One deep entropy model is known as OctSqueeze. The model utilizes ancestor nodes including a parent node, a grandparent node, and the like, in a hierarchical manner. Three multi-layer perceptron (MLP)-based modules are being used to estimate the probability distribution of the occupancy symbol of a current octree node. Another deep entropy model is known as VoxelContextNet. Different from OctSqueeze that uses ancestor nodes, VoxelContextNet employs an approach using spatial neighbor voxels to first analyze the local surface shape, and then predict the probability distribution.

Previous approaches proposed a self-supervised compression consisting of an adaptive entropy coder which operates on a tree-structured conditional entropy model. The information from the local neighborhood as well as the global topology is utilized from the octree structure. Another approach proposed a two-branch hybrid approach that digests a given point cloud and estimates the probability distribution, where one branch is based on 3D convolutions similarly done in VoxelContextNet and the other branch is using point-based operators such as PointNet++.

Examples and embodiments of non-learning based octree coding for point clouds are provided herein. The most representative non-learning-based octant coding approach is motion picture experts group (MPEG) geometry based point cloud compression (G-PCC). For a current node with its occupancy symbol to be encoded, it endeavors to use the occupancy patterns of its neighbors, such as the twenty-six (26) face/edge/vertex-adjacent neighbors, the child neighbors of three already-coded face-adjacent neighbors, and the like, to serve as the context of the coding of the current occupancy. G-PCC involves highly complex handcrafted configurations and context merging mechanisms based on principles such as rotation invariance, plane detection, angular plane detection, and the like. In this way, the most relevant probability model is obtained for arithmetic coding. In G-PCC, more flexible tree structures, such as quadtree and binary tree (QTBT), can also be used in addition to boost the compression performance.

Examples and embodiments of binary voxel-based octree coding are provided herein. Instead of coding the 8-bit occupancy symbols for the octree nodes, an alternative view to encode an octree is directly viewing each point, at a certain bitdepth, as a voxel grid. Then, encode the occupancy of that voxel grid with a binary symbol.

In related examples, one may use the occupancy bits of the neighboring voxels in the same LoD as context, to predict the occupancy probability of the current voxel. Note that the occupancy bits of the neighboring voxels together represent the occupancy state indicating whether each individual neighboring voxel is occupied or not. Then the probability is predicted via a neural network module, followed by an adaptive arithmetic coder to encode the occupancy bit. Furthermore, recent work, such as SparsePCGCv2, proposed another architecture to use the occupancy bits of the neighboring voxels in two consecutive LoDs, one parent LoD and one same LoD as context, to predict the occupancy probability of the current voxel. Both of these methods, either operate only at the current (higher) LoD or operate no two consecutive LoDs, and then require upsampling on the previous LoD to align information with the current LoD.

Different from these existing approaches, examples and embodiments herein provide an occupancy prediction model that operates at the resolution of the previous (parent) LoD, rather than operating at the same LoD as the current voxel whose occupancy is to be predicted. As a result, a method described herein enjoys a reduced computational complexity compared to the existing approaches.

Examples and embodiments are provided herein of a modified binary voxel-based octree coding scheme. To predict the binary occupancy probability of each child node/bit at a particular octree level, examples and embodiments provided herein propose to do all processing at the parent level, thus incurring a reduced computational and memory complexity.

A system overview of modified binary voxel-based octree coding embodiments and examples provided herein may include a hierarchical coding structure. Examples provided herein compress an octree hierarchically, by directly encoding the binary occupancies of the voxels.

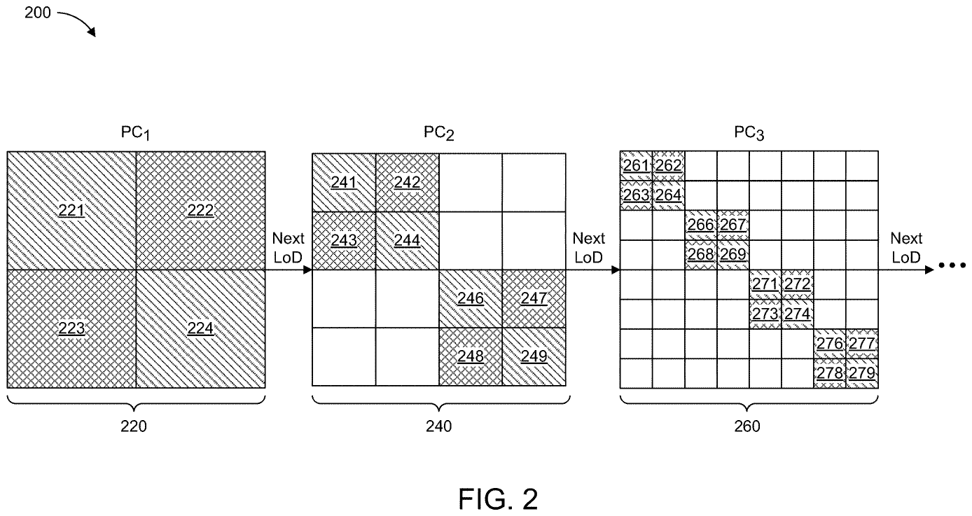

FIG. 2 is a construction diagram illustrating an example LoD construction of a point cloud. Given an input point cloud with a bit depth of n, examples provided herein encode and decode it in a hierarchical manner, as illustrated in an example shown in construction diagram 200. In an example shown in construction diagram 200, black indicates a voxel is occupied (a value “1” is placed in that voxel), and gray and white indicates a voxel is empty (a value “0” is placed in that voxel).

On the encoder side, one first may construct its coarsest voxel representation as a first point cloud (PC), such as PC₁ 220. PC₁ 220 is firstly encoded and sent as a first bitstream BS₁. BS₁ may include the voxels in PC₁ 220 and may include black voxel 221, gray voxel 222, gray voxel 223 and black voxel 224. Then the next LoD, PC₂ 240, may be constructed. By comparing PC₂ 240 and PC₁ 220, one may know that to encode PC₂ 240, only its black and gray voxels need to be encoded because the white voxels are guaranteed to be empty by looking at PC₁ 220, with empty gray voxel 222 and empty gray voxel 223. Hence, the black and gray voxels of PC₂ 240 are encoded and sent as a second bitstream BS₂. Specifically, black voxel 241, gray voxel 242, gray voxel 243, black voxel 244, black voxel 246, gray voxel 247, gray voxel 248, and black voxel 249 may be encoded and sent on BS₂. BS₂ may include the voxels in PC₂ 240.

Next, one may construct an even finer LoD, PC₃ 260. Again, by comparing PC₃ 260 and PC₂ 240, one may encode only the black and gray voxels to represent PC₃ 260, leading to a third bitstream BS₃. The white voxels of PC₃ 260 are guaranteed to be empty by looking at the white voxels and gray voxels 242, 243, 247, 248 of PC₂ 240. Specifically, black voxel 261, gray voxel 262, gray voxel 263, black voxel 264, black voxel 266, gray voxel 267, gray voxel 268, black voxel 269, black voxel 271, gray voxel 272, gray voxel 273, black voxel 274, black voxel 276, gray voxel 277, gray voxel 278, and black voxel 279 may be encoded and sent on BS₃. This procedure may repeat until the finest bit depth of the point cloud is reached. For example, the procedure may continue to a next LoD beyond PC₃ 260.

Similarly, on the decoder side, the decoder first reconstructs the coarsest LoD of the PC₁ 220 by decoding the first bitstream BS₁. By referring to the already decoded PC₁ 220, decoder knows that only the black and gray voxels in PC₂ 240 would be included in the second bitstream BS₂. Hence, the decoder decodes BS₂ and put the decoded bits to the black and grey voxels of PC₂ 240 to reconstruct it. Similarly, the third bitstream BS₃ is also decoded, and the decoded bits are assigned to the black and gray voxels of PC₃ 260 for reconstruction. This procedure may repeat until the finest bit depth of the point cloud is reached.

Examples and embodiments are provided herein of voxel grid coding via deep context-based entropy coding. One may encode the occupancy bits of the voxels within each LoD. To achieve this, provided herein is a learning based entropy model that takes the whole point cloud at the previous LoD as well as the decoded voxels at the current LoD to output the binary occupancy probability at the current LoD. The occupancy probability prediction may be done for children of only occupied nodes from previous LoD. Moreover, the prediction may be done in a sequential bitwise fashion starting with the occupancy probability prediction of the child in the first octant. Afterwards, the ground truth occupancy of this first child, at the current LoD, and the ground truth occupancy from the previous LoD may be used to predict the occupancy probability of the child in the second octant, and so on.

The entropy model proposed herein aims to predict the occupancy probability at each LoD using a feature descriptor characterizing the local surface. This feature extractor can be a convolution based architecture or a point based architecture, or a combination of both as proposed in other approaches. A feature extractor provided herein operates on the current available, or decoded, ground truth occupancy at current LoD to produce a feature which is combined with the feature from the previous LoD and this combined feature is finally used to predict the occupancy probability of voxels at current LoD.

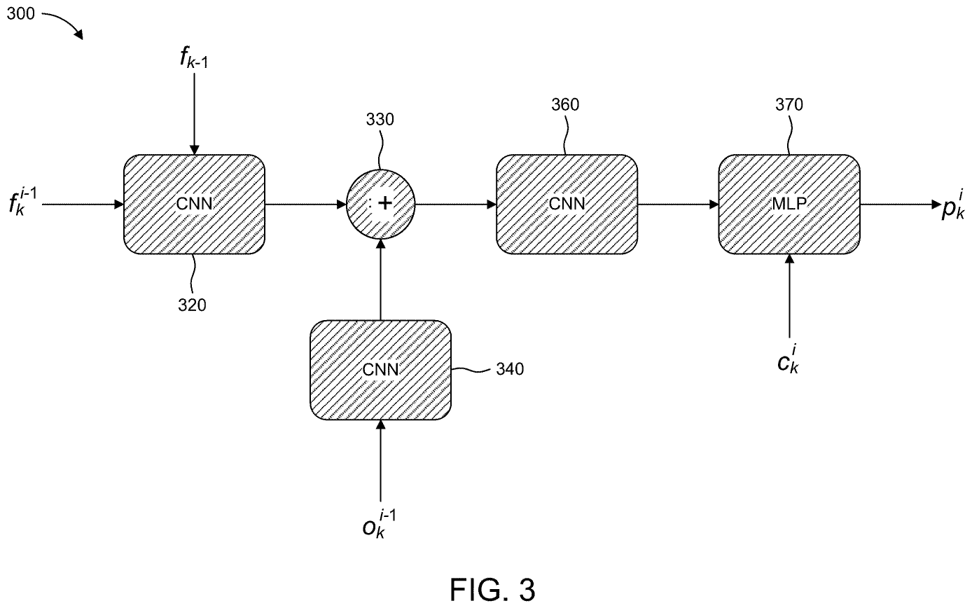

FIG. 3 is an architectural diagram illustrating an example basic proposed architecture. Specifically, architectural diagram 300 shows an example architecture with a convolution based feature extractor for one particular child at one particular LoD.

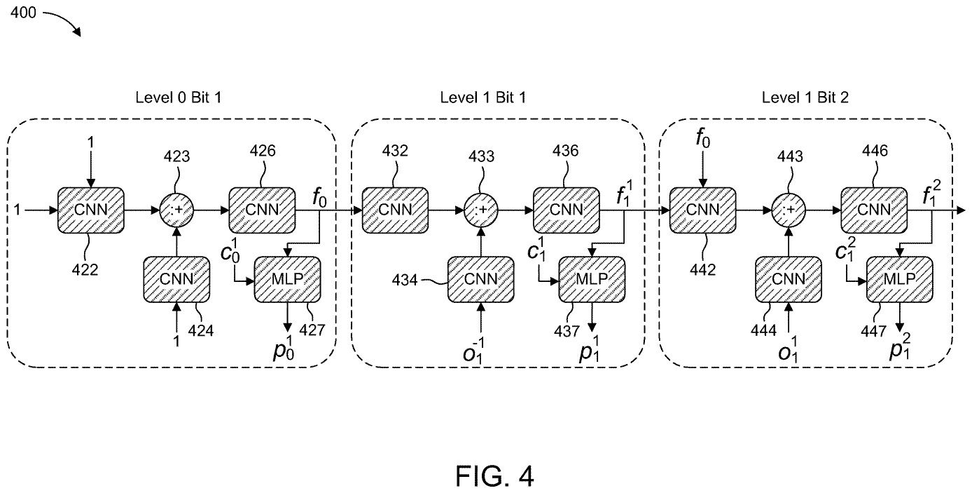

FIG. 4 is an architectural diagram illustrating an example unrolled basic proposed architecture. An example in architectural diagram 400 shows an unrolled version of same architecture starting from the root LoD and the first two child nodes for the first LoD.

Provided herein is the basic architecture of the proposed examples and embodiments. At the start of decoding a new LoD, traditional binary voxel-based octree coding architectures begin by upsampling the feature of the last decoded LoD to bring it to the current LoD resolution and then use this upsampled LoD as a starting point. Furthermore, all preceding calculations are done at the higher resolution of the new LoD. This procedure is necessary to achieve appropriate resolution for the initial feature but also incurs computational cost for the upsampling step and all preceding calculations.

In contrast to this traditional approach, embodiments and examples provided herein propose to not upsample the feature from last LoD and maintain its resolution. Additionally, for producing the occupancy probability for the children nodes at the new LoD, embodiments and examples provided herein propose to view them as additional channels and each new channel (child) is predicted from the last LoD and the preceding channels (children).

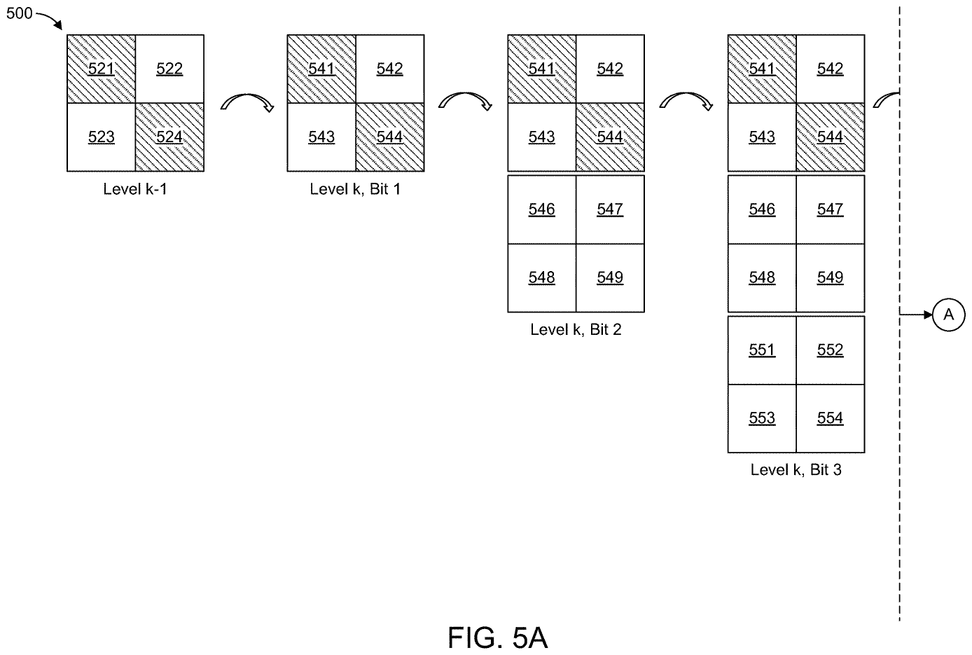

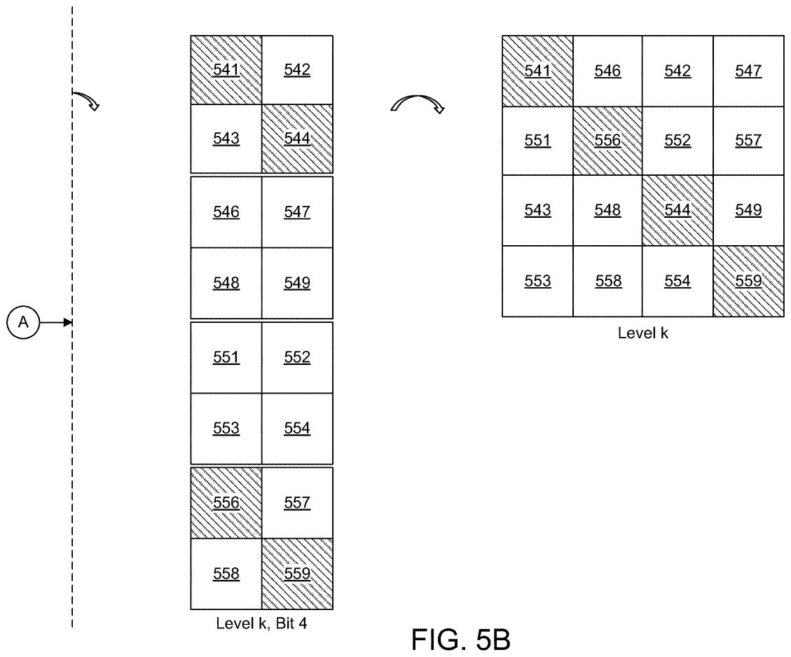

FIG. 5A and FIG. 5B are an operation diagram illustrating an example of a prediction operation from bit to bit. The spatial resolution is the same as previous LoD during the encoding of bits, as shown in operation diagram 500. After decoding bits from the current LoD, they are placed at appropriate 3D locations to obtain current decoded LoD. A visual example of an operation for producing the occupancy probability for the children nodes at the new LoD is shown in operation diagram 500.

Specifically, in a basic version of the embodiments provided herein, to predict the occupancy probability of the current bit at the current LoD, the feature from the previous LoD and feature from previous bit(s) are accessed and transformed by a 3D convolution module to produce a combined updated feature. Additionally, the ground truth occupancy of the previous bit may also be accessed and transformed into a feature using another 3D convolution module. It should be highlighted that all features share the same location in the 3D space with just having different channels. Finally, both the features may be combined into a final comprehensive feature describing the information from the previous level and the previous bits. This final comprehensive feature, along with the contextual information about the current bit, such as bit location, bit index, and the like, may be fed into an MLP-based fully connected module to output the occupancy probability of the current bit.

FIG. 3 includes an example of an architectural diagram to predict the occupancy probability of the current bit at the current LoD. Specifically, in FIG. 3, the current LoD may be represented by k and the previous LoD may be represented by k−1, while the current bit may be represented by i and the previous bit may be represented by i−1. Accordingly, the feature from the previous LoD may be represented by fₖ₋₁ and the feature from the previous bit may be represented by

$${f}_{k}^{i - 1} .$$

These features may be accessed and transformed by 3D convolutional neural network (CNN) module 320. Further, the ground truth occupancy of the previous bit may be represented by

$${O}_{k}^{i - 1} ,$$

which may be accessed and transformed by 3D CNN module 340. Further, both the features may be combined by combination module 330 into a comprehensive feature. The combination module 330 can either add the features or concatenate the input features. This comprehensive feature may be fed into CNN module 360. Further, the output of CNN module 360 may be fed into MLP module 370. Contextual information about the current bit may include bit location, bit index, and the like. This contextual information may be represented by

$${C}_{k}^{i} ,$$

and may also be fed into MLP module 370. Moreover, MLP module 370 may output the occupancy probability of the current bit, which may be represented by

$${P}_{k}^{i} .$$

After the occupancy of all bits at current LoD are obtained, they are arranged into the 3D space at their appropriate location to make complete occupancy of the current LoD. Moreover, the features for each bit are also arranged accordingly to construct a complete feature of current LoD which can be used by the next LoD.

FIG. 4 includes an example of an unrolled architectural diagram. Specifically, in FIG. 4, the feature of the previous level before Level 0 may be initialized to a default vector of all 1's and the feature of the previous bit before Bit 1 at Level 0 may be initialized to a default vector of all 1's, and both occupancies may be accessed and transformed by CNN module 422. Further, the occupancy of the previous bit before Bit 1 at Level 0 may also be initialized to a default 1 occupancy, which may be accessed and transformed by CNN 424. The output of CNN module 422 and CNN module 424 may be combined by combination module 423 into a comprehensive feature. This comprehensive feature may be fed into CNN 426. Further, the output of CNN module 426 may be represented by f₀, which may be fed into MLP module 427 as well as output to CNN module 432 for use in predicting Level 1, Bit 1. Contextual information about the current bit may be represented by C₀¹, and may also be fed into MLP module 427. Further, MLP module 427 may output the occupancy probability of the current Level 0, Bit 1, which may be represented by P₀¹.

For Level 1, Bit 1, CNN module 432 accesses and transforms f₀ from Level 0. Further, the occupancy of the previous bit before Bit 1 at Level 1 may be represented by O₁⁰ and initialized to an all 1's occupancy, which may be accessed and transformed by CNN module 434. The output of CNN module 432 and CNN module 434 may be combined by combination module 433 into a comprehensive feature.

This comprehensive feature may be fed into CNN module 436. Further, the output of CNN module 436 may be represented by f₁¹, which may be fed into MLP module 437 as well as output to CNN module 442 for use in predicting Level 1, Bit 2. Contextual information about the current bit may be represented by C₁¹, and may also be fed into MLP module 437. Further, MLP module 437 may output the occupancy probability of the current Level 1, Bit 1, which may be represented by P₁¹.

For Level 1, Bit 2, CNN module 442 accesses and transforms f₀ from Level 0, Bit 1 as well as f₁¹ from Level 1, Bit 1. Further, the occupancy of the previous Bit 1 at Level 1 may be represented by O₁¹, which may be accessed and transformed by CNN module 444. The output of CNN module 442 and CNN module 444 may be combined by combination module 443 into a comprehensive feature. This comprehensive feature may be fed into CNN module 446. Further, the output of CNN module 446 may be represented by f₁², which may be fed into MLP module 447 as well as output to a further CNN module for use in predicting a further bit, such as for Level 1, Bit 3, for example.

Additionally or alternatively, the output of CNN module 446 may be used in predicting a further bit in a further level, such as Level 2, Bit 1. Contextual information about the current bit may be represented by C₁², and may also be fed into MLP module 447. Further, MLP module 447 may output the occupancy probability of the current Level 1, Bit 2, which may be represented by P₁².

FIG. 5A and FIG. 5b include an example of a prediction operation from bit to bit. As shown in FIG. 5A, the previous level, Level k−1, has an occupied voxel 521, unoccupied voxel 522, unoccupied voxel 523 and occupied voxel 524. The current level and first bitstream, Level k, Bitstream 1, has an occupied voxel 541, unoccupied voxel 542, unoccupied voxel 543 and occupied voxel 544. Level k, Bitstream 1 may also be referred to as Level k, Bit 1, as shown in an example in operation diagram 500. The known voxels from Level k−1 may be used to predict occupancy of voxels 541, 542, 543, 544 in Bitstream 1, as explained elsewhere herein. Similarly, to predict voxels 546, 547, 548 and 549 in Bitstream 2, the ground truth occupancy of previous voxels 541, 542, 543, and 544 may be used. Further, the spatial resolution for each Level k Bitstream i is the same as the previous Level k−1 during the encoding of the voxels.

In like manner, the known voxels from Bitstream 2 may be used to predict occupancy of voxels in Bitstream 3, which may also be referred to as Bit 3. As shown, Level k, Bitstream 3 has unoccupied voxels 551, 552, 553, 554.

As shown in FIG. 5B, known voxels from Bitstream 3 may be used to predict occupancy of voxels in Bitstream 4, or Bit 4. As shown, Level k, Bitstream 4 has occupied voxel 556, unoccupied voxel 557, unoccupied voxel 558 and occupied voxel 559.

In an example in FIG. 5A and FIG. 5B, upon decoding all of the voxels from Level k, at the conclusion of the decoding of Bitstream 4, the voxels are arranged at their appropriate locations to obtain the complete occupancy of the currently decoded LoD. For example, decoded Level k is shown on the right-hand side of FIG. 5B where the voxels are placed at appropriate locations. In an example, the location may be 3D locations.

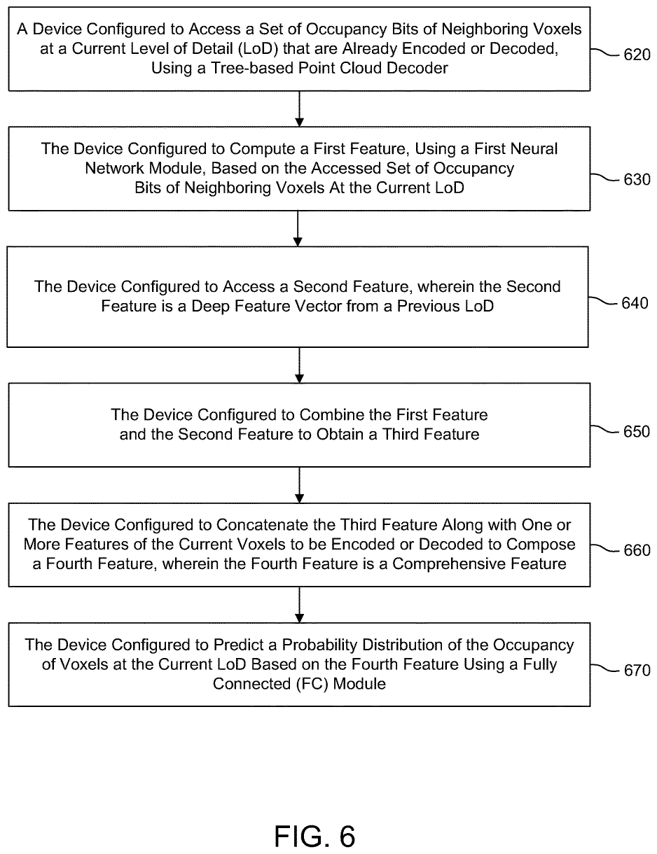

FIG. 6 is a flowchart diagram of an example of predicting voxel occupancy using occupancy bits of already encoded or decoded neighboring voxels. As shown in an example in flowchart diagram 600, a device may be configured to access a set of occupancy bits of neighboring voxels at a current LoD that are already encoded or decoded, using a tree-based point cloud decoder 620. In an example, the device may be a wireless device. For example, the device may be a WTRU. In a further example, the device may be a decoder implemented by one or more processors. In another example, the device may be an encoder implemented by one or more processors.

Further, the device may be configured to compute a first feature, using a first neural network module, based on the accessed set of occupancy bits of neighboring voxels at the current LoD 630. In an example, the first neural network module may be a first convolution based neural network module. Also, the device may be configured to access a second feature. In an example, the second feature may be a deep feature vector from a previous LoD 640. In an additional example or an alternative example, the second feature may be computed using a second neural network module or a third neural network module. In an example, the second neural network module may be a convolution based module, such as a second convolution based neural network module.

Further, the device may be configured to combine the first feature and the second feature to obtain a third feature 650. Additionally, the device may be configured to concatenate the third feature along with one or more features of the current voxels to be encoded or decoded to compose a fourth feature, wherein the fourth feature is a comprehensive feature 660.

Further, the device may be configured to predict the probability distribution of the occupancy of voxels at the current LoD based on the fourth feature using the second neural network module 670. In an example, the second neural network module may be a fully connected (FC) module. In a further example, the second neural network module may be a convolution based module, such as a second convolution based neural network module. In another example, the second neural network module may be part of an MLP-based module.

In a further example, the device may obtain a fifth feature, using the third neural network module, based on the second feature. In a further example, the third neural network module may be a convolution based module, such as a third convolution based neural network module. In an additional or alternative example, the device may obtain the fifth feature using the second neural network model. Also, in an additional or alternative example, the fifth feature may be combined with the first feature to obtain the third feature.

In an additional example, the device may access a sixth feature. The sixth feature may be based on bits already encoded or decoded voxels at the current LoD. Further, the fifth feature may be obtained by combining the second feature and the sixth feature using the second neural network module or the third neural network module, in another example.

In a further example, the fourth feature may be composed further based on the sixth feature combined with the third feature. Additionally or alternatively, the fourth feature may be composed further based on the second feature combined with the third feature.

In a further example, the prediction of the probability distribution of the occupancy of voxels at the current LoD may be further based on contextual information about the current voxels encoded or decoded. In another example, the second feature may be based on a first point cloud of the previous LoD. Also, the occupancy bits of the neighboring voxels at the current LoD may be received in a bitstream, in an example.

In yet a further example, the device may reconstruct an octree structure based on the probability distribution of the occupancy of the voxels at the current LoD. Further, the device may reconstruct a second point cloud based on leaf nodes of the reconstructed octree structure. Moreover, the device may then transmit bits of the second point cloud.

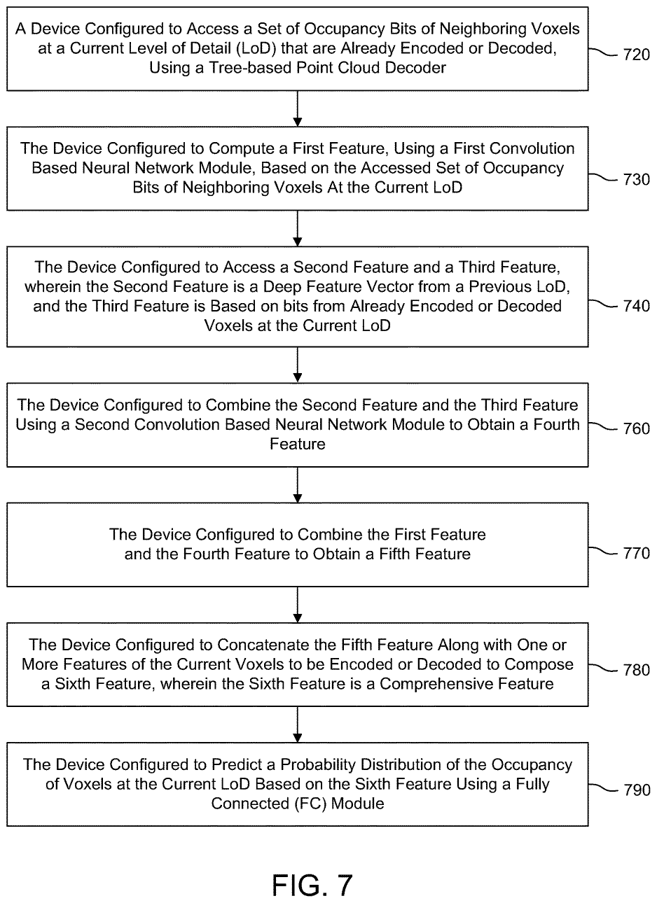

FIG. 7 is a flowchart diagram of another example of predicting voxel occupancy using occupancy bits of already encoded or decoded neighboring voxels. As shown in an example in flowchart diagram 700, a device may be configured to access a set of occupancy bits of neighboring voxels at a current LoD that are already encoded or decoded, using a tree-based point cloud decoder 720. In an example, the device may be a wireless device. For example, the device may be a WTRU. In a further example, the device may be a decoder implemented by one or more processors.

Further, the device may be configured to compute a first feature, using a first convolution based neural network module, based on the accessed set of occupancy bits of neighboring voxels at the current LoD 730. Also, the device may be configured to access a second feature and a third feature. In an example, the second feature may be a deep feature vector from a previous LoD. In a further example, the third feature may be based on bits from already encoded or decoded voxels at the current LoD 740. In an example, the second feature may be computed using a convolution based neural network module. Moreover, the device may be configured to combine the second feature and the third feature using a using a second convolution based neural network module to obtain a fourth feature 760.

Further, the device may be configured to combine the first feature and the fourth feature to obtain a fifth feature 770. Additionally, the device may be configured to concatenate the fifth feature along with one or more features of the current voxels to be encoded or decoded to compose a sixth feature, wherein the sixth feature is a comprehensive feature 780. Further, the device may be configured to predict the probability distribution of the occupancy of voxels at the current LoD based on the sixth feature using a fully connected (FC) module 790.

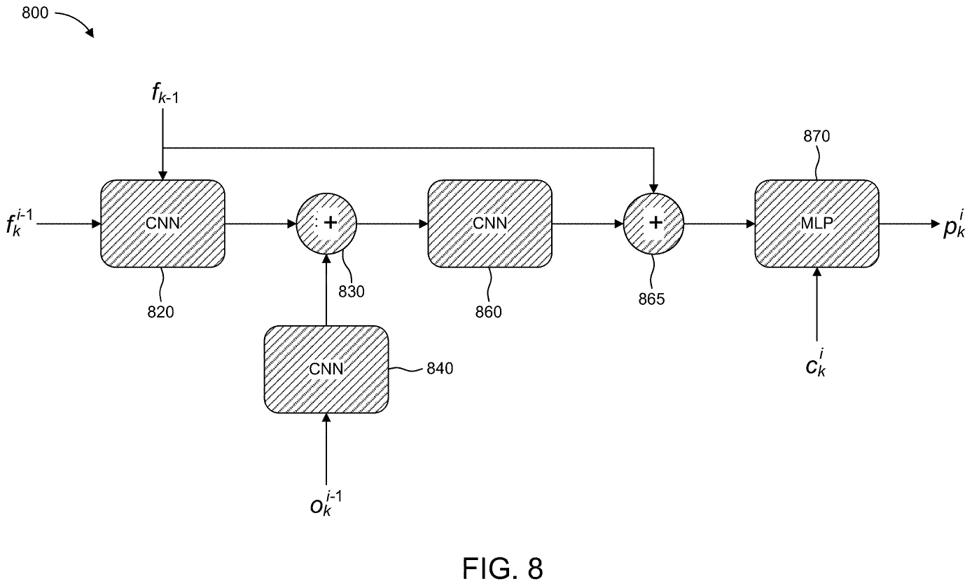

In a further example, the second feature may be further combined with the fifth feature, and the combination may itself be concatenated with one or more features of the current voxels to be encoded or decoded to compose the sixth feature. As above, the second feature may be a deep feature vector from a previous LoD, and the fourth feature may be a comprehensive feature. Examples of the second feature being further combined with the fifth feature, concatenated with the fifth feature, or both, are provided below regarding FIG. 8.

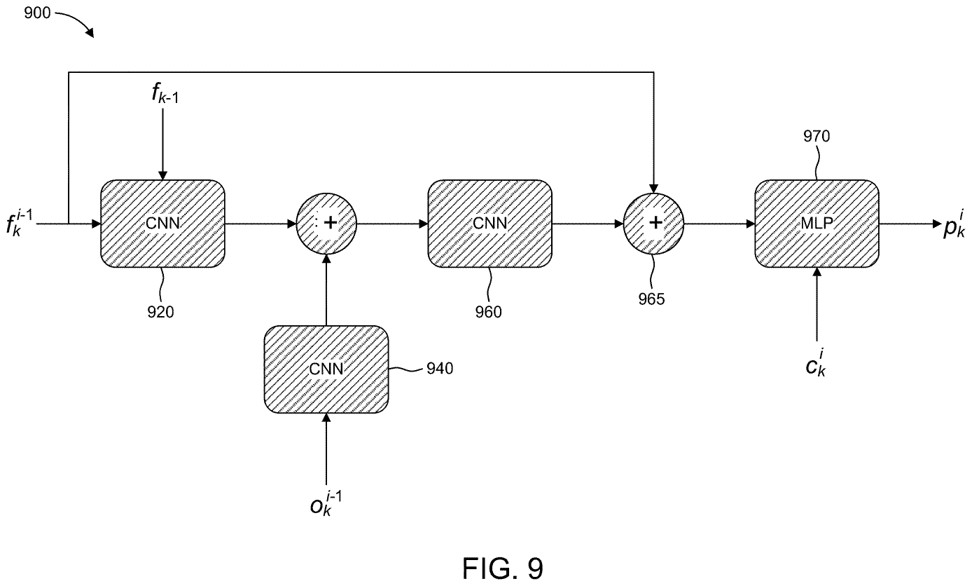

In another example, the third feature may be further combined with the fifth feature, and the combination may itself be concatenated with one or more features of the current voxels to be encoded or decoded to compose the sixth feature. As above, the third feature may be a deep feature vector from already encoded or decoded voxels at a current LoD, and the sixth feature may be a comprehensive feature. Examples of the and the third feature being further combined with the fifth feature, concatenated with the fifth feature, or both, are provided below regarding FIG. 9.

FIG. 8 is an architectural diagram illustrating an example of proposed architecture with residual connection from a feature of a previous level. In one example, the basic architecture can be enhanced by adding residual/skip connections from the feature of previous level to the final comprehensive feature. This can help alleviate the vanishing gradient problem through the residual connection.

An example including this architecture is shown in architectural diagram 800. For example, the feature from the previous LoD, fₖ₋₁, and the feature from the previous bit,

$${f}_{k}^{i - 1} ,$$

may be accessed and transformed by CNN module 820. In examples, one or both of these features may be deep features. Further, the ground truth occupancy of the previous bit,

$${O}_{k}^{i - 1} ,$$

may be accessed and transformed by 3D CNN module 840. Further, both the features may be combined by combination module 830 into a comprehensive feature.

This comprehensive feature may be fed into CNN module 860. Further, the output of CNN module 860 may be combined with the feature from the previous LoD, fₖ₋₁, by combination module 765 depicting a residual connection. This combination is made by way of addition of the two features.

The resulting output may be fed into MLP module 870. Contextual information,

$${C}_{k}^{i} ,$$

may also be fed into MLP module 870. As above, the contextual information about the current bit may include bit location, bit index, and the like. Moreover, MLP module 870 may output the occupancy probability of the current bit,

$${P}_{k}^{i} .$$

FIG. 9 is an architectural diagram illustrating an example of proposed architecture with residual connection from a feature of a previous bit. In another example, the skip connection can be made from the feature of the previous bit to the final feature.

An example including this architecture is shown in architectural diagram 900. architectural diagram 900. For example, the feature from the previous LoD, fₖ₋₁ and the feature from the previous bit,

$${f}_{k}^{i - 1} ,$$

may be accessed and transformed by CNN module 920. In examples, one or both of these features may be deep features. Further, the ground truth occupancy of the previous bit,

$${O}_{k}^{i - 1} ,$$

may be accessed and transformed by 3D CNN module 940. Further, both the features may be combined by combination module 930 into a comprehensive feature.

This comprehensive feature may be fed into CNN module 960. Further, the output of CNN module 960 may be combined with the feature from the previous bit,

$${f}_{k}^{i - 1}$$

by combination module 965 depicting a residual connection. This combination is made by way of addition of the two features.

The resulting output may be fed into MLP module 970. Contextual information,

$${C}_{k}^{i} ,$$

may also be fed into MLP module 970. As above, the contextual information about the current bit may include bit location, bit index, and the like. Moreover, MLP module 970 may output the occupancy probability of the current bit,

$${P}_{k}^{i} .$$

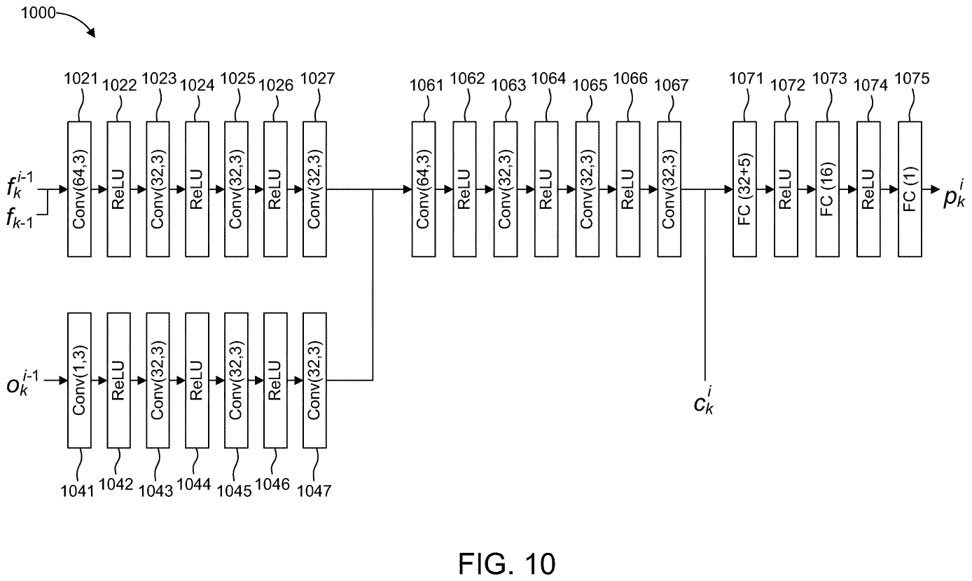

FIG. 10 is an architectural diagram illustrating an example of proposed basic architecture with example network details. Examples provided herein may use the architecture shown in architectural diagram 1000. For example, the feature from the previous LoD, fₖ₋₁ and the feature from the previous bit,

$${f}_{k}^{i - 1} ,$$

may be accessed and transformed by a CNN module, which may include convolutional layer 1021, rectified linear unit (RelU) layer 1022, convolutional layer 1023, RelU layer 1024, convolutional layer 1025, RelU layer 1026, and convolutional layer 1027. In an example, the CNN module may be similar to CNN module 320 in FIG. 3. In a specific example, convolutional layer 1021 may have a dimension of 64 as the output feature and a 3 as the kernel size. In a further example, the convolutional layer 1021 may have a dimension of 64 as the input feature as well. In another example, the convolutional layer 1021 may have a number of channels of 128. Further, the kernel size may be 3×3×3. In a further example, the RelU layers, such as RelU layer 1022, may be a non-linearity layer.

Specifically, in an example in FIG. 10, the feature from the previous LoD, fₖ₋₁ and the feature from the previous bit,

$${f}_{k}^{i - 1} ,$$

may be fed into the convolutional layer 1021, whose output may in turn be fed into the RelU layer 1022. The output of the RelU layer 1022 may be fed into convolutional layer 1023, which may have a dimension of 32 as the output feature, input feature, or both, and a 3 as the kernel size. The output of the convolutional layer 1023 may be fed into RelU layer 1024, whose output may in turn be fed into convolutional layer 1025. The convolutional layer 1025 may also have a dimension of 32 as the output feature, input feature, or both, and a 3 as the kernel size. The output of the convolutional layer 1025 may be fed into RelU layer 1026, whose output may in turn be fed into convolutional layer 1027. Convolutional layer 1027 may also have a dimension of 32 as the output feature, input feature, or both, and a 3 as the kernel size.

Further, the ground truth occupancy of the previous bit,

$${O}_{k}^{i - 1} ,$$

may be accessed and transformed by a CNN, which may be a 3D CNN module. In an example, the CNN module may be similar to CNN module 340 in FIG. 3. The CNN module may include convolutional layer 1041, RelU layer 1042, convolutional layer 1043, RelU layer 1044, convolutional layer 1045, RelU layer 1046, and convolutional layer 1027. In an example, convolutional layer 1041 may have a dimension of 1 and a kernel size of 3. The output of convolutional layer 1041 may be fed into RelU layer 1042, whose output may in turn be fed into convolutional layer 1043. Convolutional layer 1043 may have a dimension of 32 as the output feature, input feature, or both, and a 3 as the kernel size. The output of convolutional layer 1043 may be fed into RelU layer 1044, whose output may in turn be fed into convolutional layer 1045. Convolutional layer 1045 may also have a dimension of 32 as the output feature, input feature, or both, and a 3 as the kernel size. The output of convolutional layer 1045 may be fed into RelU layer 1046, whose output may in turn be fed into convolutional layer 1047. Convolutional layer 1047 may also have a dimension of 32 as the output feature, input feature, or both, and a 3 as the kernel size.

Further, the output of both convolutional layer 1027 and convolutional layer 1047 may be combined into a comprehensive feature. In an example, the output of convolutional layer 1027 and convolutional layer 1047 may be combined by a combination module. In an example, the combination module may be similar to combination module 330 in FIG. 3. In an example, the combination may be by way of concatenation. This comprehensive feature may be fed into another CNN module. In an example, the CNN module may be similar to CNN module 360 in FIG. 3.

This CNN module may include convolutional layer 1061, RelU layer 1062, convolutional layer 1063, RelU layer 1064, convolutional layer 1065, RelU layer 1066, and convolutional layer 1067. In an example, convolutional layer 1061 may have a dimension of 64 and a kernel size of 3. The output of convolutional layer 1061 may be fed into RelU layer 1062, whose output may in turn be fed into convolutional layer 1063. Convolutional layer 1063 may have a dimension of 32 as the output feature, input feature, or both, and a 3 as the kernel size. The output of convolutional layer 1063 may be fed into RelU layer 1064, whose output may in turn be fed into convolutional layer 1065. Convolutional layer 1065 may also have a dimension of 32 as the output feature, input feature, or both, and a 3 as the kernel size. The output of convolutional layer 1065 may be fed into RelU layer 1066, whose output may in turn be fed into convolutional layer 1067. Convolutional layer 1067 may also have a dimension of 32 as the output feature and a 3 as the kernel size.

Moreover, the output of convolutional layer 1067, and hence of this CNN module may be fed into an MLP module, along with contextual information,

$${C}_{k}^{i} .$$

As above, the contextual information about the current bit may include bit location, bit index, and the like. In an example, the MLP module may be similar to MLP module 370 in FIG. 3. Further, the MLP module may include an FC module layer 1071, RelU layer 1072, FC module layer 1073, RelU layer 1074, and FC module layer 1075. The contextual information,

$${C}_{k}^{i} ,$$

may have a dimension of 5, while the dimension of the output of convolutional layer 1067 may be 32. Accordingly, the FC module layer 1071 may have an input dimension of 32+5. In an example, the FC module layer 1071 may have a combined dimension of 37, which may be an input dimension. Further, 37 may also be the dimension of the output of the FC module layer 1071. The output of FC module layer 1071 may be fed into RelU layer 1072, whose output may in turn be fed into FC module layer 1073. In an example, FC module layer 1073 may have a dimension of 16. The dimension of 16 may be an input dimension, an output dimension, or both. The output of FC module layer 1073 may be fed into RelU layer 1074, whose output may in turn be fed into FC module layer 1075. In an example, FC module layer 1075 may have a dimension of 1. The dimension of 1 may be an input dimension, an output dimension, or both. In an example, a dimension of 1 is desired in the output. Accordingly, FC module layer 1075 may output the occupancy probability of the current bit,

$${P}_{k}^{i} .$$

As a result, the occupancy probability of the current bit,

$${P}_{k}^{i}$$

may be the output of the MLP module.

The layers provided for the modules in the examples above are for illustrative purposes. In operation, additional or fewer layers may be used in each module to suit the context of the data, bitstreams and voxels required for processing.

Examples and embodiments are provided herein of shared or unshared network parameters. In one embodiment the network parameters for all modules in the network are shared across all bits and all levels. In another embodiment the network parameters for all modules are shared across levels, but are unshared for different bits. In yet another embodiment, the network parameters are never shared and are separate for each level and each bit.

In another example enhanced embodiment, one can use the features and ground truth of all previous bits at the same LoD rather than just using the most recent decoded bit. Such an approach may be unlike the basic proposed architecture.

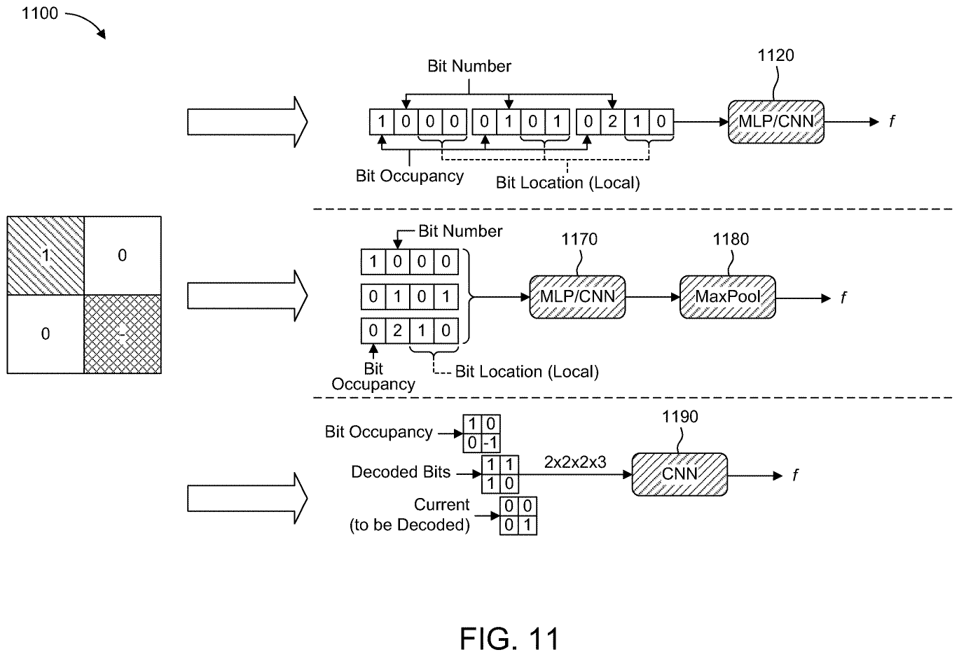

FIG. 11 is an extraction diagram illustrating examples of feature extraction from all previously decoded bits. As shown in examples in extraction diagram 1100, all child bits of a voxel from a previous LoD have been decoded, except for the last one which is currently being decoded. As shown in FIG. 11, the upper left voxel has a bit of 1, the upper right voxel has a bit of 0, the lower left voxel has a bit of 0 and the lower right voxel's bit is yet unknown as it is currently being decoded.

In an example shown in the top subfigure of FIG. 11, the occupancies of all previous bits along with the context information for each bit are concatenated into one single vector and then transformed into a feature using either a point based shared MLP or a voxel based convolution module 1120. As shown in FIG. 11, the upper left voxel has a bit occupancy of 1, a bit number of 0 and a bit location of 0, 0. The bit location may represent row 0 and column 0 as the upper left location. In an example, the bit location may be a local location. Further, the upper right voxel has a bit occupancy of 0, a bit number of 1 and a bit location of 0, 1. The bit location may represent row 0 and column 1. Similarly, the lower left voxel has a bit occupancy of 0, a bit number of 2 and a bit location of 1, 0, which may represent row 1 and column 0.

In another example shown in the middle subfigure of FIG. 11, the shared MLP or the voxel based convolution module 1170 operates on all bits, with their context information, in parallel to produce initial features which are then max-pooled 1180 into a single feature summarizing the information of all previous bits. The information used in the middle subfigure is the same as the top subfigure, as seen in FIG. 11, but the in the middle subfigure the operations are performed in parallel on each decoded bit.

In yet another example, shown in the bottom subfigure of FIG. 11, the occupancies of all previous bits along with the context information for each bit are placed in a local 2×2×2 3D volume with k channels (depending on the available context) and then operated on by a voxel based convolution module 1190 to obtain the feature summarizing the information of all previous bits. As shown in FIG. 11, the bit occupancy of the voxels in the bottom subfigure corresponds to the voxels on the left, with the lower right voxel's bit shown as −1 because it is yet unknown as it is currently being decoded.

Decoded bits of the voxels are shown by a 1 representing a bit that has been decoded and a 0 representing a bit that is yet unknown as it is currently being decoded. Accordingly, the upper left voxel, the upper right voxel, and the lower left voxel are represented by a 1 since they have already been decoded. Further, the lower right voxel is represented by a 0 it has yet to be decoded or is currently being decoded.

Similarly, the current bits of the voxels, or to be decoded voxels, are shown by a 0 representing a bit that is not being decoded, because, for example, it has already been decoded. Further, a 0 may represent a bit that is currently being decoded.

In the basic proposal, the feature from the previous LoD is directly used at the current LoD. In a different example version, the ground truth occupancy of the previous LoD can be used to construct a new feature in place of directly using the feature from the previous LoD. The same 3D convolution module operating on the occupancy at the current LoD can be used as all operations are being done at a lower resolution and the bits at the current LoD are being considered as channels of the previous LoD.

In another example, the 3D convolution modules can be swapped for point based modules which are more suited for handling sparse point cloud data like LiDAR scans. In yet another example, the 3D convolution module can be replaced with sparse 3D convolution modules which are more computationally efficient and can also handle sparse point clouds.

Further examples use advanced feature extraction modules. The basic convolution, sparse convolution, and point-based modules can be replaced with their advanced counterparts as well like ResNets, Voxel Transformer, and Point Transformer.

The proposed architecture is intended for lossless octree entropy coding of point cloud data. However, the proposal can be easily modified perform lossy octree coding by the keeping the same network architecture but thresholding the obtained occupancy probability of each bit at the current LoD. The bits with occupancy probability over a threshold may be considered occupied and the rest may be considered to be unoccupied. All remaining details may stay the same.

Although features and elements are described above in particular combinations, one of ordinary skill in the art will appreciate that each feature or element can be used alone or in any combination with the other features and elements. Further, one of ordinary skill in the art will appreciate that embodiments and examples provided herein include a device configured to perform the methods described herein. Also, the embodiments and examples provided herein include means for performing or means configured to perform the methods described herein. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a device, the method comprising:
accessing a set of occupancy bits of neighboring voxels at a current level of detail (LoD) that are already encoded or decoded, using a tree-based point cloud decoder;
computing a first feature, using a first neural network module upon a whole point cloud frame at the current LoD, based on the accessed set of occupancy bits of neighboring voxels at the current LoD, wherein the first neural network module is a convolution based neural network module;
accessing a second feature, wherein the second feature is a deep feature vector from a previous LoD;
combining the first feature and the second feature using a second neural network module upon the whole point cloud frame at the current LoD to obtain a third feature, wherein the second neural network module is a convolution based neural network module;
concatenating the third feature along with one or more features of the current voxels to be encoded or decoded to compose a fourth feature, wherein the fourth feature is a comprehensive feature; and
predicting a probability distribution of occupancy of voxels at the current LoD based on the fourth feature using a third neural network module.

2. The method of claim 1, further comprising:
obtaining a fifth feature, using a fourth neural network module, based on the second feature, wherein the fourth neural network module is a convolution based neural network module, and wherein the third feature is obtained by combining the first feature and the fifth feature.

3. (canceled)

4. The method of claim 2, further comprising:
accessing a sixth feature, wherein the sixth feature is based on bits from already encoded or decoded voxels at the current LoD, wherein the fifth feature is obtained by combining the second feature and the sixth feature using the second neural network module.

5-6. (canceled)

7. The method of claim 1, wherein the fourth feature is composed further based on the second feature combined with the third feature.

8. The method of claim 1, wherein the third neural network module is part of a multi-layer perceptron (MLP)-based module.

9. The method of claim 1, wherein the prediction is further based on contextual information about the current voxels to be encoded or decoded.

10. The method of claim 1, wherein the second feature is based on a first point cloud of the previous LoD.

11. The method of claim 1, wherein the occupancy bits of the neighboring voxels at the current LoD are received in a bitstream.

12. The method of claim 1, further comprising:
reconstructing an octree structure based on the probability distribution of the occupancy of the voxels at the current LoD;
reconstructing a second point cloud based on leaf nodes of the reconstructed octree structure; and
transmitting bits of the second point cloud.

13. (canceled)

14. The method of claim 1, wherein the second neural network module is a fully connected (FC) module.

15-16. (canceled)

17. A device comprising:
a processor; and
a transceiver operatively coupled to the processor; wherein
the processor and the transceiver are configured to access a set of occupancy bits of neighboring voxels at a current level of detail (LoD) that are already encoded or decoded, using a tree-based point cloud decoder;
the processor is configured to compute a first feature, using a first neural network module upon a whole point cloud frame at the current LoD, based on the accessed set of occupancy bits of neighboring voxels at the current LoD, wherein the first neural network module is a convolution based neural network module;
the processor is configured to access a second feature, wherein the second feature is a deep feature vector from a previous LoD;
the processor is configured to combine the first feature and the second feature using a second neural network module upon the whole point cloud frame at the current LoD to obtain a third feature, wherein the second neural network module is a convolution based neural network module;
the processor is configured to concatenate the third feature along with one or more features of the current voxels to be encoded or decoded to compose a fourth feature, wherein the fourth feature is a comprehensive feature; and
the processor is configured to predict a probability distribution of occupancy of voxels at the current LoD based on the fourth feature using a third neural network module.

18. The device of claim 17, wherein the processor is further configured to obtain a fifth feature, using a fourth neural network module, based on the second feature, wherein the fourth neural network module is a convolution based neural network module, and wherein the third feature is obtained by combining the first feature and the fifth feature.

19. (canceled)

20. The device of claim 18, wherein the processor and the transceiver are further configured to access a sixth feature, wherein the sixth feature is based on bits from already encoded or decoded voxels at the current LoD, wherein the fifth feature is obtained by combining the second feature and the sixth feature using the second neural network module.

21-22. (canceled)

23. The device of claim 17, wherein the fourth feature is composed further based on the second feature combined with the third feature.

24. The device of claim 17, wherein the third neural network module is part of a multi-layer perceptron (MLP)-based module.

25. The device of claim 17, wherein the prediction is further based on contextual information about the current voxels to be encoded or decoded.

26. The device of claim 17, wherein the second feature is based on a first point cloud of the previous LoD.

27. The device of claim 17, wherein the occupancy bits of the neighboring voxels at the current LoD are received in a bitstream.

28. The device of claim 17, wherein the processor is further configured to reconstruct an octree structure based on the probability distribution of the occupancy of the voxels at the current LoD; wherein the processor is further configured to reconstruct a second point cloud based on leaf nodes of the reconstructed octree structure; and wherein the processor and the transceiver are further configured to transmit bits of the second point cloud.

29. (canceled)

30. The device of claim 17, wherein the third neural network module is a fully connected (FC) module.

31-32. (canceled)
